(19) United States
(12) Patent Application Publication
(10) Pub. No.: US 2012/0080640 A1
(43) Pub. Date: Apr. 5, 2012

(54) THERMALLY CONDUCTIVE RESIN COMPOSITION

(75) Inventor: Yuji Saga, Utsunomiya-Shi (JP)

(73) Assignee: E.I. DU PONT DE NEMOURS AND COMPANY, Wilmington, DE (US)

(21) Appl. No.: 13/248,060

(22) Filed: Sep. 29, 2011

Related U.S. Application Data
(60) Provisional application No. 61/388,114, filed on Sep. 30, 2010.

(51) Int. Cl. C09K 5/00

(52) U.S. Cl. 252/75

(57) ABSTRACT

Thermally conductive resin compositions comprising polymer, calcium fluoride, fibrous filler and optionally, polymeric toughening agent are particularly useful for metal/polymer hybrid parts and as encapsulants.

### CROSS REFERENCE TO RELATED APPLICATIONS

This application claims the benefit of priority to U.S. Provisional Application No. 61/388,114, filed Sep. 30, 2010.

### FIELD OF THE INVENTION

The present invention relates to thermally conductive resin compositions useful as encapsulants for electric and electronics device components which are fabricated in a configuration comprising a thermoplastic body that requires thermal management.

### BACKGROUND OF THE INVENTION

Because of their excellent mechanical and electrical insulation properties, polymeric resin compositions are used in a broad range of applications such as in automotive parts, electrical and electronic parts, machine parts and the like. In many cases, because of the design flexibility they permit, sealing capability and their electrical insulation properties, polymer resin compositions can be used as encapsulants, insulators, housings and frames for electrical and electronics devices or motors. However, for such applications encapsulating polymer compositions need to have high thermal conductivities, especially with the downsizing trend of some electrical devices associated with increased operating temperature. Another important requirement for encapsulating polymer compositions is that their Coefficients of Linear Thermal Expansions (CLTEs) should be close to CLTEs of materials encapsulated with the polymer compositions to retain seal integrity while releasing heat generated by the encapsulated devices. In general, higher loading with thermally conductive filler in polymer leads to higher thermal conductivity and lower CLTE because the fillers' CLTEs are often lower than polymers' CLTEs. However, high filler loadings often decreases flow-ability of polymer compositions in melt forming processes, and that can lead to failure of sealing performance or damage of core devices encapsulated with the polymer compositions. Another important requirement for housings or frames is mechanical strength. Thus, polymer compositions having higher thermal conductivity, electrically insulation, lower CLTE, higher mechanical strength and good flow-ability is desired.

Tailoring properties of encapsulating polymers has been achieved utilizing different strategies:

Japanese patent application publication 2003-040619 discloses a method of surface treating calcium fluoride powder with a silane coupling agent and blending the coated powder with thermoplastic resins and, optionally, fillers to produce a thermally conductive composition. However, CLTEs obtained in the compositions are not so much low, and mechanical strength and stiffness are not enough to be used as structural parts. The compositions described herein are not disclosed.

US patent application publication 2005-176835 and Japanese patent application publication 2003-040619 disclose polymer compositions comprising thermoplastic polymer and calcium fluoride and, optionally, fibrous fillers to produce a thermally conductive composition. However, CLTEs obtained in the compositions are relatively high, and mechanical strength and stiffness are not enough to be used as structural parts. The presence of specific compositions containing calcium fluoride and fibrous fillers with specific amount ratio is not mentioned. Thus, it is desired to more efficiently increase the thermal conductivity of such compositions, while CLTE is decreased to make CLTE of polymer composition closer to that of the material overmolded with the polymer. At the same time high mechanical strength and good flowability should be attained; the properties being especially useful in an encapsulates, insulators, housings and frames for electrical and electronics devices or motors, overcoming the aforementioned problems.

### SUMMARY OF THE INVENTION

Disclosed is a thermally conductive polymer composition, comprising:
(a) about 15 to about 55 weight percent of at least one thermoplastic polymer;
(b) about 15 to about 50 weight percent of calcium fluoride; and
(c) greater than 30 to about 50 weight percent of fibrous filler;
   wherein the thermoplastic polymer is selected from the group consisting of hexamethylene terephthalamide/2-methylpentamethylene terephthalamide copolyamide (polyamide 6,T/D,T) and polyarylene sulfide.

### DETAILED DESCRIPTION OF THE INVENTION

The present invention concerns a composition comprising fibrous filler dispersed with calcium fluoride in an insulating thermoplastic polymer matrix. The respective amounts of calcium fluoride and fibrous fillers needed to achieve thermal conductivity.

As used herein, the term “enhanced thermal conductivity” is intended to mean a thermal conductivity of at least about 0.5 W/mk determined using a commercially available thermal conductivity analyzer following ASTM F-433-77.

As used herein, the term CLTE is measured on molded parts, and its value is a ratio of expansion of the mold part in mold-flow direction from lowest possible operating temperature to the highest possible operating temperature divided by the difference of the lowest and highest temperature. CLTE can vary depending on thickness of mold parts, molding conditions and is range of measurement temperature.

CLTE, in terms that takes into account mechanical strength such as tensile strength and elongation that can be modified or improved by the additives, is represented by a ratio of CLTE divided by tensile elongation (TE) so exhibited, that is, CLTE/TE. For encapsulants, compositions with lower CLTE/TE ratio provide more desirable performance. Preferred are thermoplastic resin compositions exhibiting CLTE/TE ratio of 20 ppm/° C.•% or lower wherein the CLTE is measured between −40 and 150° C. using ASTM D696 method. These materials are highly preferred materials for encapsulating compositions.

Preferred compositions have a combination of thermal conductivity of 0.5 W/mk or higher, as measured with ASTM method F-433-77; and a CLTE/TE ratio of 20 ppm/° C.•% or lower, wherein the CLTE is measured between −40 and 150° C. using ASTM D696 method.

The composition of the present invention comprises (a) at least one thermoplastic polymer, (b) calcium fluoride, (c) fibrous filler.

(a) The thermoplastic polymer is a polymer matrix of the composition, in other words the one or more polymers are in a continuous phase. Useful thermoplastic polymers include polycarbonates, polyolefins such as polyethylene and polypropylene, polyacetals, acrylics, vinyls, fluoropolymers, polyamides, polyesters, polysulfones, polyarylene sulfides, liquid crystal polymers such as aromatic polyesters, polyetherimides, polyamideimides, polyacetals, polyphenylene oxides, polyarylates, polyetheretherketones (PEEK), polyetherketoneketones (PEKK), and syndiotactic polystyrenes, and blends thereof.

Preferred are polyesters, polyamides, polyarylene sulfides and liquid crystal polymers (LCPs).

More preferred thermoplastic polyesters include polyesters having an inherent viscosity of 0.3 or greater and that are, in general, linear saturated to condensation products of diols and dicarboxylic acids, or reactive derivatives thereof. Preferably, they will comprise condensation products of aromatic dicarboxylic acids having 8 to 14 carbon atoms and at least one diol selected from the group consisting of neopentyl glycol, cyclohexanedimethanol, 2,2-dimethyl-1,3-propane diol and aliphatic glycols of the formula HO(CH₂)ₙOH where n is an integer of 2 to 10. Up to 20 mole percent of the diol may be an aromatic diol such as ethoxylated bisphenol A, sold under the tradename Dianol® 220 by Akzo Nobel Chemicals, Inc.; hydroquinone; biphenol; or bisphenol A. Up to 50 mole percent of the aromatic dicarboxylic acids can be replaced by at least one different aromatic dicarboxylic acid having from 8 to 14 carbon atoms, and/or up to 20 mole percent can be replaced by an aliphatic dicarboxylic acid having from 2 to 12 carbon atoms. Copolymers may be prepared from two or more dials or reactive equivalents thereof and at least one dicarboxylic acid or reactive equivalent thereof or two or more dicarboxylic acids or reactive equivalents thereof and at least one diol or reactive equivalent thereof. Difunctional hydroxy acid monomers such as hydroxybenzoic acid or hydroxynaphthoic acid or their reactive equivalents may also be used as comonomers.

Preferred polyesters include poly(ethylene terephthalate) (PET), poly(1,4-butylene terephthalate) (PBT), poly(1,3-propylene terephthalate) (PPT), poly(1,4-butylene 2,6-naphthalate) (PBN), poly(ethylene 2,6-naphthalate) (PEN), poly(1,4-cyclohexylene dimethylene terephthalate) (PCT), and copolymers and mixtures of the foregoing. Also preferred are 1,4-cyclohexylene dimethylene terephthalate/isophthalate copolymer and other linear homopolymer esters derived from aromatic dicarboxylic acids, including isophthalic acid; bibenzoic acid; naphthalenedicarboxylic acids including the 1,5-; 2,6-; and 2,7-naphthalenedicarboxylic acids; 4,4′-diphenylenedicarboxylic acid; bis(p-carboxyphenyl)methane; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid, and glycols selected from the group consisting of 2,2-dimethyl-1,3-propane diol; neopentyl glycol; cyclohexane dimethanol; and aliphatic glycols of the general formula HO(CH₂)ₙOH where n is an integer from 2 to 10, e.g., ethylene glycol; 1,3-trimethylene glycol; 1,4-tetramethylene glycol; -1,6-hexamethylene glycol; 1,8-octamethylene glycol; 1,10-decamethylene glycol; 1,3-propylene glycol; and 1,4-butylene glycol. Up to 20 mole percent, as indicated above, of one or more aliphatic acids, including adipic, sebacic, azelaic, dodecanedioic acid or 1,4-cyclohexanedicarboxylic acid can be present. Also preferred are copolymers derived from 1,4-butanediol, ethoxylated bisphenol A, and terephthalic acid or reactive equivalents thereof. Also preferred are random copolymers of at least two of PET, PBT, and PPT, and mixtures of at least two of PET, PBT, and PPT, and mixtures of any of the forgoing.

The thermoplastic polyester may also be in the form of copolymers that contain poly(alkylene oxide) soft segments (blocks). The poly(alkylene oxide) segments are present in about 1 to about 15 parts by weight per 100 parts per weight of thermoplastic polyester. The poly(alkylene oxide) segments have a number average molecular weight in the range of about 200 to about 3,250 or, preferably, in the range of about 600 to about 1,500. Preferred copolymers contain poly(ethylene oxide) and/or poly(tetramethylenether glycol) incorporated into a PET or PBT chain. Methods of incorporation are known to those skilled in the art and can include using the poly(alkylene oxide) soft segment as a comonomer during the polymerization reaction to form the polyester. PET may be blended with copolymers of PBT and at least one poly(alkylene oxide). A poly(alkylene oxide) may also be blended with a PET/PBT copolymer. The inclusion of a poly(alkylene oxide) soft segment into the polyester portion of the composition may accelerate the rate of crystallization of the polyester.

Preferred polyamides include semi-crystalline polyamide and amorphous polyamide.

The semi-crystalline polyamide includes aliphatic or semi-aromatic semi-crystalline polyamides.

The semi-crystalline aliphatic polyamide may be derived from aliphatic and/or alicyclic monomers such as one or more of adipic acid, sebacic acid, azelaic acid, dodecanedoic acid, or their derivatives and the like, aliphatic C₆-C₂₀ alkylenediamines, alicyclic diamines, lactams, and amino acids. Preferred diamines include bis(p-aminocyclohexyl)methane; hexamethylenediamine; 2-methylpentamethylenediamine; 2-methyloctamethylenediamine; trimethylhexamethylenediamine; 1,8-diaminooctane; 1,9-diaminononane; 1,10-diaminodecane; 1,12-diaminododecane; and m-xylylenediamine. Preferred lactams or amino acids include 11-aminododecanoic acid, caprolactam, and laurolactam.

Preferred aliphatic polyamides include polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; and polyamide 6,13.

The semi-aromatic semi-crystalline polyamides are one or more homopolymers, copolymers, terpolymers, or higher polymers that are derived from monomers containing aromatic groups. Examples of monomers containing aromatic groups are terephthalic acid and its derivatives. It is preferred that about 5 to about 75 mole percent of the monomers used to make the aromatic polyamide used in the present invention contain aromatic groups, and it is still more preferred that about 10 to about 55 mole percent of the monomers contain aromatic groups.

Examples of preferred semi-crystalline semi-aromatic polyamides include poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T); hexamethylene adipamide/hexamethylene terephthalamide/hexamethylene isophthalamide copolyamide (polyamide 6,6/6,T/6,I); poly(caprolactam-hexamethylene terephthalamide) (polyamide 6/6,T); and the like.

In the present invention, a semi-crystalline semi-aromatic polyamide is preferred in terms of heat resistance, dimension stability and moisture resistance at high temperature

Semi-crystalline semi-aromatic polyamides derived from monomers containing aromatic groups are especially advantageous for uses in applications that require a balance of properties (e.g., mechanical performance, moisture resistance, heat resistance, etc.) in the polyamide composition as well as higher thermal conductivity.

In the present invention, amorphous polyamides can be contained in the polymer composition without giving significant negative influence on the properties. They are one or more homopolymers, copolymers, terpolymers, or higher polymers that are derived from monomers containing isophthalic acid and/or dimethyldiaminodicyclohexylmethane groups.

In the preferred amorphous polyamide, the polyamide consists of a polymer or copolymer having repeating units derived from a carboxylic acid component and an aliphatic diamine component. The carboxylic acid component is isophthalic acid or a mixture of isophthalic acid and one or more other carboxylic acids wherein the carboxylic acid component contains at least 55 mole percent, based on the carboxylic acid component, of isophthalic acid. Other carboxylic acids that may be used in the carboxylic acid component include terephthalic acid and adipic acid. The aliphatic diamine component is hexamethylene diamine or a mixture of hexamethylene diamine and 2-methyl pentamethylene diamine and/or 2-ethyltetramethylene diamine, in which the aliphatic diamine component contains at least 40 mole percent, based on the aliphatic diamine component, of hexamethylene diamine.

Examples of preferred amorphous polyamides include poly(hexamethylene terephthalamide/hexamethylene isophthalamide) (polyamide 6,T/6,I), poly(hexamethylene isophthalamide) (polyamide 6,I), poly(metaxylylene isophthalamide/hexamethylene isophthalamide) (polyamide MXD,I/6,I), poly(metaxylylene isophthalamide/metaxylylene terephthalamide/hexamethylene isophthalamide) (polyamide MXD,I/MXD,T/6,I/6,T), poly(metaxylylene isophthalamide/dodecamethylene isophthalamide) (polyamide MXD,I/12,I), poly(metaxylylene isophthalamide) (polyamide MXD,I), poly(dimethyldiaminodicyclohexylmethane isophthalamide/dodecanamide) (polyamide MACM,I/12), poly(dimethyldiaminodicyclohexylmethane isophthalamide/dimethyldiaminodicyclohexylmethane terephthalamide/dodecanamide) (polyamide MACM,I/MACM,T/12), poly(hexamethylene isophthalamide/dimethyldiaminodicyclohexylmethane isophthalamide/dodecanamide) (polyamide 6,I/MACM,I/12), poly(hexamethylene isophthalamide/hexamethylene terephthalamide/dimethyldiaminodicyclohexylmethane isophthalamid/dimethyldiaminodicyclohexylmethane terephthalamide) (polyamide 6,I/6,T/MACM,I/MACM,T), poly(hexamethylene isophthalamide/hexamethylene terephthalamide/dimethyldiaminodicyclohexylmethane isophthalamid/dimethyldiaminodicyclohexylmethane terephthalamide/dodecanamide) (polyamide 6,I/6,T/MACM,I/MACM,T/12), poly(dimethyldiaminodicyclohexylmethane isophthalamide/dimethyldiaminodicyclohexylmethane dodecanamide) (polyamide MACM,I/MACM,12) and mixtures thereof.

When an amorphous polyamide is contained, the semicrystalline polyamide is present in about 40 to about 100 (and preferably about 70 to about 100) weight percent, based on the total amount of semicrystalline and amorphous polyamide present.

The poly(arylene sulfide) useful in the invention is mainly composed of —(Ar—S)— (wherein Ar is an arylene group) as a repeating unit. Examples of usable arylene groups include a p-phenylene group, a m-phenylene group, an o-phenylene group, a substituted phenylene group, a p,p′-diphenylenesulfone group, a p,p′-biphenylene group, a p,p′-diphenyleneether group, a p,p′-diphenylenecarbonyl group and a naphthalene group. In this case, there is also such a case that copolymer including different kinds of repeating units among arylene sulfide groups constituted of above-described arylene groups is preferable from the standpoint of processability of the composition, in addition to polymers including the same repeating unit, that is, homopolymer.

For the homopolymer, one including a p-phenylene sulfide group, which uses a p-phenylene group as the arylene group, is used particularly preferably. For the copolymer, the combination of different two or more kinds of arylene sulfide groups, which are composed of above-described arylene groups, can be employed, but, among these, a combination including a p-phenylene sulfide group and m-phenylene sulfide group is particularly preferably used. Further, one including 70% by mol or more of a p-phenylene sulfide group, preferably 80% by mol or more is suitable from the standpoint of physical properties such as heat-resistant properties, flowability (moldability) and mechanical properties.

Among these poly(arylene sulfide) resins, a high-molecular-weight polymer substantially having a linear structure, which is obtained by condensation polymerization from monomer including a bifunctional halogenated aromatic compound as the main body, is used particularly preferably. And, in addition to the poly(arylene sulfide) resin having a linear structure, a polymer, in which a branched structure or crosslinked structure is partially formed by using a little amount of monomer such as a polyhalo aromatic compound having three or more halogen substituents when performing condensation polymerization, can be employed, a polymer having improved moldability and processability by oxidatively or thermally crosslinking a polymer having a linear structure with relatively low molecular weight by heating at high temperatures in the presence of oxygen or an oxidizing agent, or a mixture thereof may also be employed.

By a LCP is meant a polymer that is anisotropic when tested using the TOT test or any reasonable variation thereof, as described in U.S. Pat. No. 4,118,372, which is hereby incorporated by reference. Useful LCPs include polyesters, poly(ester-amides), and poly(ester-imides). One preferred form of LCP is “all aromatic”, that is all of the groups in the polymer main chain are aromatic (except for the linking groups such as ester groups), but side groups which are not aromatic may be present.

The thermoplastic polymer can be selected from the group consisting of hexamethylene terephthalamide/2-methylpentamethylene terephthalamide copolyamide (polyamide 6,T/D,T) and polyarylene sulfide.

The thermoplastic polymer in the composition that is taken as component (a) will preferably be present in about 15 to about 55 weight percent, or more preferably about 20 to about 50 weight percent, based on the total weight of the composition.

The calcium fluoride used as component (b) in the present invention will preferably be in the form of a powder. The particles or granules can have a broad particle size distribution. Preferably, maximum particle size is less than 300 μm, and more preferably less than 200 μm. Average particle size of the said calcium fluoride will be from 0.1 μm to 60 μm, and preferably, from 1 to 20 μm for the reason that smaller particle is better for strength and elongation that leads to higher heat shock resistance. The particles which have multi-modal size distribution in their particle size can also be used.

The surface of the calcium fluoride (b) can be processed with a coupling agent, for the purpose of improving the interfacial bonding between the magnesium oxide surface and the matrix polymer. Examples of the coupling agent include silane series, titanate series, zirconate series, aluminate series, and zircoaluminate series coupling agents.

Useful coupling agents include metal hydroxides and alkoxides including those of Group IIIa thru VIIIa, Ib, IIb, IIIb, and IVb of the Periodic Table and the lanthanides. Specific coupling agents are metal hydroxides and alkoxides of metals selected from the group consisting of Ti, Zr, Mn, Fe, Co, Ni, Cu, Zn, Al, and B. Preferred metal hydroxides and alkoxides are those of Ti and Zr. Specific metal alkoxide coupling agents are titanate and zirconate orthoesters and chelates including compounds of the formula (I), (II) and (III):

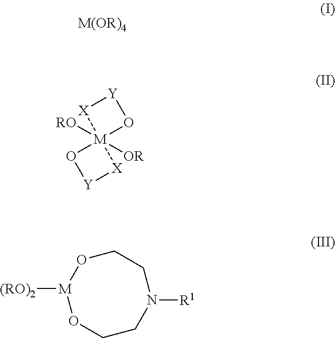

wherein

### M is Ti or Zr;

R is a monovalent C₁-C₈ linear or branched alkyl;
Y is a divalent radical selected from —CH(CH₃)—, —C(CH₃)═CH₂—, or —CH₂CH₂—;
X is selected from OH, —N(R¹)₂, —C(O)OR³, —C(O)R³, —CO₂⁻A⁺; wherein
R¹ is a —CH₃ or C₂-C₄ linear or branched alkyl, optionally substituted with a hydroxyl or interrupted with an ether oxygen; provided that no more than one heteroatom is bonded to any one carbon atom;
R³ is C₁-C₄ linear or branched alkyl;
A⁺ is selected from NH₄⁺, Li⁺, Na⁺, or K⁺.

The coupling agent can be added to the filler before mixing the filler with the polymer or can be added while blending the filler with the polymer. The additive amount of coupling agent is preferably 0.1 through 5 wt % or preferably 0.5 through 2 wt % with respect to the weight of the filler. Addition of coupling agent during the blending of the magnesium oxide with the resin has the added advantage of improving the adhesiveness between the metal used in the joint surface between the heat transfer unit or heat radiating unit and the thermally conductive polymer.

The calcium fluoride (b) will preferably be present in 15 to 50 weight percent, more preferably 25 to 40 weight percent, based on the total weight of the composition.

The fibrous filler used as component (c) in the present invention is a needle-like fibrous material. Examples of preferred fibrous fillers include wollastonite (calcium silicate whiskers), glass fibers, aluminum borate fibers, calcium carbonate fibers, titanium oxide fibers, alumina fibers and potassium titanate fibers. The fibrous filler will preferably have a weight average aspect ratio of at least 5, or more preferably of at least 10.

In the similar way processed on the surface of the calcium fluoride (b), the surface of the fibrous filler (c) can be processed with a coupling agent, for the purpose of improving the interfacial bonding between the fibrous fillers and the matrix polymer.

Component (c) fibrous filler (or fillers) will be present in greater than 30 to about 50 weight percent, or preferably greater than 30 to 45 weight percent, or more preferably greater than 30 to 40 weight percent.

Preferably, the weight ratio of (b)/(c) is preferably between 35/65 and 63/37, or more preferably between 40/60 and 60/40. If the ratio is less than 35/65, thermal conductivity of the composition will become low, and if the ratio is more than 63/37, heat shock resistance and mechanical strength of the composition will be deteriorated.

Other ingredients may also be present in the composition, particularly those that are commonly added to thermoplastic compositions. Such ingredients include toughening agent, plasticizers, nucleating agents, flame retardants, flame retardant synergists, heat stabilizers, antioxidants, dyes, pigments, mold release agents, lubricants, UV stabilizers, (paint) adhesion promoters, platy or granular fillers In one preferred type of the composition about 0.5 to about 15 weight percent, preferably about 2 to about 10 weight percent of the total composition of the polymeric toughening agent is added to the present invention. When the thermoplastic polymer is a polyester, the toughening agent will typically be an elastomer or has a relatively low melting point, generally <200° C., preferably <150° C. and that has attached to it functional groups that can react with the thermoplastic polyester (and optionally other polymers present). Since thermoplastic polyesters usually have carboxyl and hydroxyl groups present, these functional groups usually can react with carboxyl and/or hydroxyl groups. Examples of such functional groups include epoxy, carboxylic anhydride, hydroxyl (alcohol), carboxyl, and isocyanate. Preferred functional groups are epoxy, and carboxylic anhydride, and epoxy is especially preferred. Such functional groups are usually “attached” to the polymeric toughening agent by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl(meth)acrylate, glycidyl (meth)acrylate, and 2-isocyanatoethyl(meth)acrylate. In addition to ethylene and a functional (meth)acrylate monomer, other monomers may be copolymerized into such a polymer, such as vinyl acetate, unfunctionalized (meth)acrylate esters such as ethyl(meth)acrylate, n-butyl(meth)acrylate, and cyclohexyl(meth)acrylate. Preferred toughening agents include those listed in U.S. Pat. No. 4,753,980, which is hereby included by reference. Especially preferred toughening agents are copolymers of ethylene, ethyl acrylate or n-butyl acrylate, and glycidyl methacrylate.

It is preferred that the polymeric toughening agent used for polyester in this present invention contain about 0.5 to about 20 weight percent of monomers containing functional groups, preferably about 1.0 to about 15 weight percent, more preferably about 7 to about 13 weight percent of monomers containing functional groups. There may be more than one type of functional monomer present in the polymeric toughening agent. It has been found that toughness of the composition is increased by increasing the amount of polymeric toughening agent and/or the amount of functional groups. However, these amounts should preferably not be increased to the point that the composition may crosslink, especially before the final part shape is attained.

The polymeric toughening agent used with thermoplastic polyesters may also be thermoplastic acrylic polymers that are not copolymers of ethylene. The thermoplastic acrylic polymers are made by polymerizing acrylic acid, acrylate esters (such as methyl acrylate, n-propyl acrylate, isopropyl acrylate, n-butyl acrylate, n-hexyl acrylate, and n-octyl acrylate), methacrylic acid, and methacrylate esters (such as methyl methacrylate, n-propyl methacrylate, isopropyl methacrylate, n-butyl methacrylate (BA), isobutyl methacrylate, n-amyl methacrylate, n-octyl methacrylate, glycidyl methacrylate (GMA) and the like). Copolymers derived from two or more of the forgoing types of monomers may also be used, as well as copolymers made by polymerizing one or more of the forgoing types of monomers with styrene, acrylonitrile, butadiene, isoprene, and the like. Part or all of the components in these copolymers should preferably have a glass transition temperature of not higher than 0° C. Preferred monomers for the preparation of a thermoplastic acrylic polymer toughening agent are methyl acrylate, n-propyl acrylate, isopropyl acrylate, n-butyl acrylate, n-hexyl acrylate, and n-octyl acrylate.

It is preferred that a thermoplastic acrylic polymer toughening agent have a core-shell structure. The core-shell structure is one in which the core portion preferably has a glass transition temperature of 0° C. or less, while the shell portion is preferably has a glass transition temperature higher than that of the core portion. The core portion may be grafted with silicone. The shell section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition.

Suitable toughening agents for polyamides are described in U.S. Pat. No. 4,174,358. Preferred toughening agents include polyolefins modified with a compatibilizing agent such as an acid anhydride, dicarboxylic acid or derivative thereof, carboxylic acid or derivative thereof, and/or an epoxy group. The compatibilizing agent may be introduced by grafting an unsaturated acid anhydride, dicarboxylic acid or derivative thereof, carboxylic acid or derivative thereof, and/or an epoxy group to a polyolefin. The compatibilizing agent may also be introduced while the polyolefin is being made by copolymerizing with monomers containing an unsaturated acid anhydride, dicarboxylic acid or derivative thereof, carboxylic acid or derivative thereof, and/or an epoxy group. The compatibilizing agent preferably contains from 3 to 20 carbon atoms. Examples of typical compounds that may be grafted to (or used as comonomers to make) a polyolefin are acrylic acid, methacrylic acid, maleic acid, fumaric acid, itaconic acid, crotonic acid, citraconic acid, maleic anhydride, itaconic anhydride, crotonic anhydride and citraconic anhydride.

Preferred toughening agents for polyacetals include thermoplastic polyurethanes, polyester polyether elastomers, other functionalized and/or grafted rubber, and polyolefins that contain polar groups that are either grafted to their backbones or were incorporated by copolymerizing with a monomer that contained one or more polar groups. Preferable comonomers are those that contain epoxide groups, such as glycidyl methacrylate. A preferred toughening agent is EBAGMA (a terpolymer derived from ethylene, butyl acrylate, and glycidyl methacrylate).

The compositions of the present invention are preferably in the form of a melt-mixed or a solution-mixed blend, more preferably melt-mixed, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method or by mixing components other than matrix polymer with monomers of the polymer matrix and then polymerizing the monomers. The component materials may be mixed to homogeneity using a melt-mixer such as a single or twin-screw extruder, blender, kneader, Banbury mixer, etc. to give a resin composition. Part of the materials may be mixed in a melt-mixer, and the rest of the materials may then be added and further melt-mixed until homogeneous. The sequence of mixing in the manufacture of the thermally conductive polymer resin composition of this invention may be such that individual components may be melted in one shot, or the filler and/or other components may be fed from a side feeder, and the like, as will be understood by those skilled in the art.

The composition of the present invention may be formed into articles using methods known to those skilled in the art, such as, for example, injection molding, blow molding, extrusion, press molding. The present compositions are especially useful in electrical and/or electronic devices, sometimes forming in a sense metal/resin hybrids. Such articles can include those for use in motor housings, lamp housings, lamp housings in automobiles and other vehicles, electrical and electronic housings, insulation bobbin which exist between coiled wire and magnetic inducible metal core in stator of motors or generators, and housings which substantially encapsulates the stator core of motors or generators where enhanced thermal conductivity is needed. Articles made from the instant composition and incorporating metal inserts as is commonly understood by the skilled person are particularly attractive. Examples of lamp housings in automobiles and other vehicles are front and rear lights, including headlights, tail lights, and brake lights, particularly those that use light-emitting diode (LED) lamps. Examples of application in electric devices are reflector and frame of LED lights. The articles may serve as replacements for articles made from aluminum or other metals in many applications.

### Examples

### Compounding and Molding Methods

The Examples 1-13 and Comparative Examples C1-C4 listed in Table 1-3 were prepared by compounding in a 32 mm Werner and Pfleiderer twin screw extruder. Ingredients were blended together and added to the rear of the extruder except that the fillers were side-fed into a downstream barrel. Barrel temperatures were set at about 320° C. for HTN and 315° C. for PPS.

The compositions were molded into ISO test specimens on an injection molding machine for the measurement of mechanical properties and into plates of 1 mm×16 mm×16 mmm size for measurements of thermal conductivity and CLTE. Melt temperature were about 325° C. and mold temperatures were about 150° C.

Test specimens made according to this invention and so tested exhibit enhanced thermal conductivity and CLTE/TE ratio of 20 ppm/° C.•%.

### Testing Methods

Tensile strength and elongation were measured using the ISO 527-1/2 standard method. Flexural strength and modulus were measured using the 150178-1/2 standard method. Notched charpy impact was measured using the ISO 179/1eA standard method.

CLTE in mold flow direction were determined on about center portion of the plate in the temperature range from −40 to 150° C. using ASTM D696 method.

Thermal conductivity was determined on the plate using Laser Flash Method as described in ASTM E1461.

Melt viscosity was measured using a Kayeness rheometer. The melt viscosities of the pellets obtained were measured at shear rates and temperatures listed in Tables 1-3 after a residence time of 5 min in each example.

The following terms are used in Tables 1-3:

HTN refers to Zytel® HTN501, a polyamide6TDT manufactured by E.I. du Pont de Nemours and Co., Wilmington, Del.
PPS refers to Ryton® PR26, a polyarylene sulfide manufactured by Chevron Phillips Chemical Company LP
2,6-NDA refers to 2,6-napthalene dicarboxylic acid, available from BP Amoco Chemical Company.
Talc refers to talc KOSSAP® #10 that is surface modified with an aminosilane coupling agent manufactured by Nippon Talc Co., Ltd.
PED521 is a lubricant supplied from Clariant Japan. K.K.
CS-8CP is a calcium montanate supplied from Nitto Chemical Industry Co., ltd
Rubber-1 refers to TRX 301, an ethylene/propylene/hexadiene terpolymer grafted with maleic anhydride, was purchased from Dow Chemical (Midland, Mich., USA).
Rubber-2 refers to Staphyloid® IM-203, a core-shell type polymer toughening agent, supplied from Ganz Chemical Co., Ltd.
Rubber-3 refers to Elvaloy® EP4934, an ethylene/vinyl-acrylate/glycidyl methacrylate terpolymer manufactured by E.I. DuPont de Nemours and Co., Wilmington, Del.
Ultranox 626A refers to bis(2,4-di-tert-butylphenyl pentaerythritol) diphosphite.
AO-80 refers to hindered phenol based antioxidant: (Asahi Denka Co.)
DPE refers to Bis[2,2,2-tris(hydroxymethyl)ethyl]ether available from Tokyo Kasei Kogyo.
Naugard 445 refers to 4,4-di(alpha,alpha-dimethylbenzyl)diphenylamine available from Chemtura USA Corp.
Boltorn H30 refers to a dendritic polyester available from Perstorp Specialty Chemicals AB.
CaF2-1 refers to calcium fluoride power having average particle size of 30 μm that was supplied from Sankyo Seifun.
CaF2-1A refers to CaF2-1 processed with 1 weight % amino silane coupling agent, Z-6011 manufactured by Dow Corning Toray.
CaF2-2 refers to calcium fluoride powder having average particle size of 6 μm that was supplied from Sankyo Seifun.
CaF2-2A refers to CaF2-2 processed with 1 weight % amino silane coupling agent, Z-6011 manufactured by Dow Corning Toray.
CaF2-2E refers to CaF2-2 processed with 1 weight % epoxy silane coupling agent, Z-6040 manufactured by Dow Corning Toray.
GF-1 refers to FT756D, glass fibers manufactured by Owens Corning Japan Ltd. Tokyo, Japan. Diameter of the fiber is 10 μm, and its chopped fiber length is 3 mm.
GF-2 refers to ECS03T-747H, glass fibers manufactured by Nippon Electric Glass Co., Ltd. Owens Corning Japan Ltd. Diameter of the fibber is 10 μm, and its chopped fiber length is 3 mm.

TABLE 1

| | | Examples | | | | | | | |
|---|---|---|---|---|---|---|---|---|---|
| | Unit | C1 | 1 | C2 | 2 | 3 | 4 | 5 | 11 |
| HTN501 | | 37.1 | 37.1 | 37.1 | 37.1 | 22.7 | 22.7 | 22.7 | 25.4 |
| 2,6-NDA | | 1.2 | 1.2 | 1.2 | 1.2 | 0.2 | 0.2 | 0.2 | 0.5 |
| Talc | | 1 | 1 | 1 | 1 | 1 | 1 | 1 | 1 |
| Rubber-1 | | | | | | 1.4 | 1.4 | 1.4 | 2.0 |
| Rubber-2 | | | | | | 2.9 | 2.9 | 2.9 | |
| AO-80 | | 0.4 | 0.4 | 0.4 | 0.4 | 0.3 | 0.3 | 0.3 | 0.3 |
| Ultranox 626A | | 0.2 | 0.2 | 0.2 | 0.2 | 0.1 | 0.1 | 0.1 | 0.2 |
| CS-8CP | | 0.1 | 0.1 | 0.1 | 0.1 | 0.1 | 0.1 | 0.1 | 0.1 |
| CaF2-1 | | 36 | 24 | | | | | | |
| CaF2-1A | | | | | 24 | 35 | | | |
| CaF2-2 | | | | | | | 35 | | |
| CaF2-2A | | | | | | | | 35 | 31 |
| GF-1 | | 24 | 36 | 60 | 36 | 36.3 | 36.3 | 36.3 | 39.5 |
| Thermal | W/mK | 0.60 | 0.57 | 0.37 | 0.49 | 0.75 | 0.76 | 0.77 | 0.60 |
| Conductivity | | | | | | | | | |
| Relative MV | Pa · s | 200 | 315 | 340 | 317 | 459 | 504 | 485 | 300 |
| @1000/s, 325° C. | | | | | | | | | |
| Tensile strength | MPa | 94 | 165 | 260 | 169 | 123 | 131 | 143 | 166 |
| Tensile elongation | % | 0.8 | 1.4 | 1.9 | 1.5 | 1.4 | 1.2 | 1.3 | 1.3 |
| (TE) | | | | | | | | | |
| Flex Strength | MPa | 139 | 236 | 412 | 242 | 185 | 190 | 207 | 228 |
| Flex Modulus | GPa | 13.9 | 16 | 21.3 | 15.9 | 16.2 | 16.8 | 17.1 | 17.3 |
| Notched charpy | kJ/m2 | 3.3 | 4.4 | 16.5 | 4.6 | 4.9 | 4.1 | 4.9 | 4.1 |
| CLTE in MD | ppm/° C. | 22 | 17 | 12 | 18 | 21 | 21 | 24 | 14 |
| CLTE/TE | ppm/° C. · % | 27.5 | 12.1 | 6.3 | 12.0 | 15.0 | 17.5 | 18.8 | 10.8 |

All ingredient quantities are given in weight percent relative to the total weight of the composition.

TABLE 2

| | | Examples | | | | | | |
|---|---|---|---|---|---|---|---|---|
| | Unit | C3 | 6 | 7 | 8 | 9 | 10 | C4 |
| PPS | | 40 | 40 | 37 | 34 | 40 | 40 | 44 |
| CaF2-1 | | 36 | 24 | 24 | 24 | | | |
| CaF2-1E | | | | | | 24 | | |
| CaF2-2E | | | | | | | 24 | 50 |
| GF-2 | | 24 | 36 | 36 | 36 | 36 | 36 | |
| Rubber-3 | | | | 3 | 6 | | | 6 |
| MV @315′C, 997/s | Pa · s | 231 | 280 | 392 | 429 | 292 | 229 | 357 |
| Thermal | W/mK | 0.62 | 0.57 | 0.52 | 0.51 | 0.51 | 0.55 | 0.49 |
| Conductivity | | | | | | | | |
| Tensile strength | MPa | 88 | 109 | 111 | 111 | 120 | 124 | 60 |
| Tensile elongation | % | 0.9 | 0.8 | 1.0 | 1.3 | 0.9 | 0.9 | 3.4 |
| (TE) | | | | | | | | |
| Flex Strength | MPa | 144 | 170 | 174 | 173 | 188 | 190 | 115 |
| Flex Modulus | GPa | 15.4 | 19 | 16.5 | 14.2 | 17.9 | 17.5 | 5.7 |
| Notched charpy | kJ/m2 | 2.9 | 3.8 | 4.3 | 6.5 | 4.0 | 3.1 | 4.2 |
| CLTE in MD | ppm/° C. | 22.5 | 17.2 | 15.5 | 15 | 17.9 | 17.9 | 60 |
| CLTE/TE | ppm/° C. · % | 25.0 | 21.5 | 15.3 | 11.8 | 19.9 | 20.6 | 17.6 |

All ingredient quantities are given in weight percent relative to the total weight of the composition.

TABLE 3

Examples

| | Unit | 12 | 13 |
|---|---|---|---|
| HTN501 | | 21.5 | 17.3 |
| Talc | | 1 | 1 |
| Rubber-1 | | 1.3 | 1.1 |
| Rubber-2 | | 2.6 | 2.1 |
| CS-8CP | | 0.1 | 0.1 |
| DPE | | 1.2 | 1.0 |
| Naugard 445 | | 0.2 | 0.2 |
| Bortorn H30 | | 0.8 | 0.7 |
| CaF2-2A | | 35 | 33.3 |
| GF-1 | | 36.3 | 43.2 |
| Thermal Conductivity | W/mK | 0.70 | 0.83 |
| Relative MV @1000/s, | Pa · s | 240 | 517 |
| 325° C. | | | |
| Tensile strength | MPa | 138 | 127 |
| Tensile elongation(TE) | % | 0.9 | 0.7 |
| Flex Strength | MPa | 216 | 200 |
| Flex Modulus | GPa | 19.6 | 23.1 |
| Notched charpy | kJ/m2 | 6.2 | 5.3 |
| CLTE in MD | ppm/° C. | 15 | 15 |
| CLTE/TE | ppm/° C. · % | 16.7 | 21.4 |

All ingredient quantities are given in weight percent relative to the total weight of the composition.

What is claimed is:

1. A thermally conductive polymer composition, comprising:
(a) about 15 to about 55 weight percent of at least one thermoplastic polymer;
(b) about 15 to about 50 weight percent of calcium fluoride; and
(c) greater than 30 to about 50 weight percent of fibrous filler;
wherein the thermoplastic polymer is selected from the group consisting of hexamethylene terephthalamide/2-methylpentamethylene terephthalamide copolyamide (polyamide 6,T/D,T) and polyarylene sulfide.

2. The composition of claim 1 wherein said (c) fibrous filler is at least one selected from the group consisting of glass fibers, wallastonites, titanium oxide fiber and alumina fiber.

3. The composition as recited in any one of the preceding claims wherein said (b) calcium fluoride is coated with a coupling agent selected from silane series, titanate series, zirconate series, aluminate series, and zircoaluminate series.

4. The composition as recited in any one of the preceding claims wherein average particle size of said (b) calcium fluoride is less than 20 μm.

5. The composition as recited in any one of the preceding claims having a thermal conductivity of 0.5 W/mk or higher, as measured with ASTM method F-433-77.

6. The composition as recited in any one of the preceding claims having a CLTE/TE ratio of 20 ppm/° C.•% or lower, wherein the CLTE is measured between −40 and 150° C. using ASTM D696 method.

7. The composition as recited in any one of the preceding claims having a combination of thermal conductivity of 0.5 W/mk or higher, as measured with ASTM method F-433-77; and a CLTE/TE ratio of 20 ppm/° C.•% or lower, wherein the CLTE is measured between −40 and 150° C. using ASTM D696 method

8. An article made by metal insert molding with the composition of any one of the preceding claims.

9. An article encapsulated with the composition of any one of the preceding claims.
